(19) United States
(12) Patent Application Publication
(10) Pub. No.: US 2020/0142340 A1
(43) Pub. Date: May 7, 2020

(54) SHEET TRANSPORT DEVICE AND IMAGE FORMING APPARATUS

(71) Applicant: FUJI XEROX CO., LTD., Tokyo (JP)

(72) Inventors: Shoichi MAEDA, Kanagawa (JP); Keisuke MATSUZAWA, Kanagawa (JP); Yusuke ITOZAKI, Kanagawa (JP)

(73) Assignee: FUJI XEROX CO., LTD., Tokyo (JP)

(21) Appl. No.: 16/398,286

(22) Filed: Apr. 30, 2019

(30) Foreign Application Priority Data
Nov. 7, 2018 (JP) 2018-209491

(51) Int. Cl. G03G 15/00; B65H 5/36; B65H 5/06

(52) U.S. Cl. CPC G03G 15/6529; G03G 2215/00679; B65H 5/062; B65H 5/36

(57) ABSTRACT

A sheet transport device includes: a first transport roller that transports a sheet and that has two first nip parts, which are spaced apart in a sheet width direction and nip portions of the sheet; a second transport roller that transports the sheet, that is disposed upstream of the first transport roller in a sheet transport direction, that has a second nip part, which nips a portion of the sheet at a position different from at least one of the first nip parts in the width direction, and that stops exerting a force that transports the sheet when the sheet has been transferred to the first transport roller; and two tension-applying parts that are provided on the first transport roller, on the outer side of the two first nip parts in the width direction, and that apply, to the sheet, tension pulling the sheet outward in the width direction.

### CROSS-REFERENCE TO RELATED APPLICATIONS

This application is based on and claims priority under 35 USC 119 from Japanese Patent Application No. 2018-209491 filed Nov. 7, 2018.

### BACKGROUND

### (i) Technical Field

The present disclosure relates to a sheet transport device and an image forming apparatus.

### (ii) Related Art

In a sheet transport device disclosed in Japanese Unexamined Patent Application Publication No. 2003-160255, multiple roller bodies provided in a driven roller are fixed to individual shafts. The shafts are supported by support members, and the support members are fixed to an attachment plate. The shafts of the roller bodies located on the right side with respect to the center in the transport width direction are inclined such that their circumferential surfaces face a diagonally right direction, and the shafts of the roller bodies located on the left side with respect to the center in the transport width direction are inclined such that their circumferential surfaces face a diagonally left direction.

### SUMMARY

The related-art sheet transport device includes a first transport roller that transports a sheet, and a second transport roller that is located upstream of the first transport roller in the sheet transport direction and transfers the sheet to the first transport roller. In this configuration, once the second transport roller has transferred the sheet to the first transport roller, the second transport roller stops applying a transport force to the sheet. Hence, the sheet that is being transported by the first transport roller is subjected to a force pulling upstream in the sheet transport direction exerted by the second transport roller, which has stopped applying the transport force.

The first transport roller sometimes has two first nip parts, which are spaced apart in the sheet width direction and nip portions of a sheet, and the second transport roller has a second nip part, which nips a portion of the sheet at a position different from at least one of the first nip parts in the sheet width direction. In this case, the first transport roller applies, to the sheet, only a force that transports the sheet downstream in the sheet transport direction.

With this configuration, when a sheet that is being transported by the first transport roller is subjected to a force pulling upstream in the sheet transport direction as a result of the second transport roller stopping, creases extending in the sheet transport direction may be formed in the sheet.

Aspects of non-limiting embodiments of the present disclosure relate to suppressing the formation of creases extending in the sheet transport direction in a sheet, compared with a case where the first transport roller applies, to the sheet, only a force that transports the sheet downstream in the sheet transport direction.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided a sheet transport device including: a first transport roller that transports a sheet and that has two first nip parts, which are spaced apart in a sheet width direction and which nip portions of the sheet; a second transport roller that transports the sheet, that is disposed upstream of the first transport roller in a sheet transport direction, that has a second nip part, which nips a portion of the sheet at a position different from at least one of the first nip parts in the sheet width direction, and that stops exerting a force that transports the sheet when the sheet has been transferred to the first transport roller; and two tension-applying parts that are provided on the first transport roller, on the outer side of the two first nip parts in the sheet width direction, and that apply, to the sheet, tension pulling the sheet outward in the sheet width direction.

### BRIEF DESCRIPTION OF THE DRAWINGS

Exemplary embodiments of the present disclosure will be described in detail based on the following figures, wherein:

FIG. 1 is a perspective view of a transport unit, serving as a sheet transport device, according to a first exemplary embodiment of the present disclosure;

FIG. 2 is a plan view of the transport unit, serving as the sheet transport device, according to the first exemplary embodiment of the present disclosure;

FIG. 3 is a plan view of the transport unit, serving as the sheet transport device, according to the first exemplary embodiment of the present disclosure;

FIG. 4 shows the configuration, in outline, of an image forming apparatus according to the first exemplary embodiment of the present disclosure;

FIG. 5 shows the configuration, in outline, of the image forming apparatus according to the first exemplary embodiment of the present disclosure;

FIG. 6 is a perspective view of a transport unit, serving as a sheet transport device, according to a comparison example for the first exemplary embodiment of the present disclosure;

FIG. 7 is a plan view of the transport unit, serving as the sheet transport device, according to the comparison example for the first exemplary embodiment of the present disclosure;

FIG. 8 is a perspective view of a transport unit, serving as a sheet transport device, according to a second exemplary embodiment of the present disclosure;

FIG. 9 is a front view of the transport unit, serving as the sheet transport device, according to the second exemplary embodiment of the present disclosure; and

FIG. 10 is a front view of a transport unit, serving as a sheet transport device, according to a third exemplary embodiment of the present disclosure.

### DETAILED DESCRIPTION

### First Exemplary Embodiment

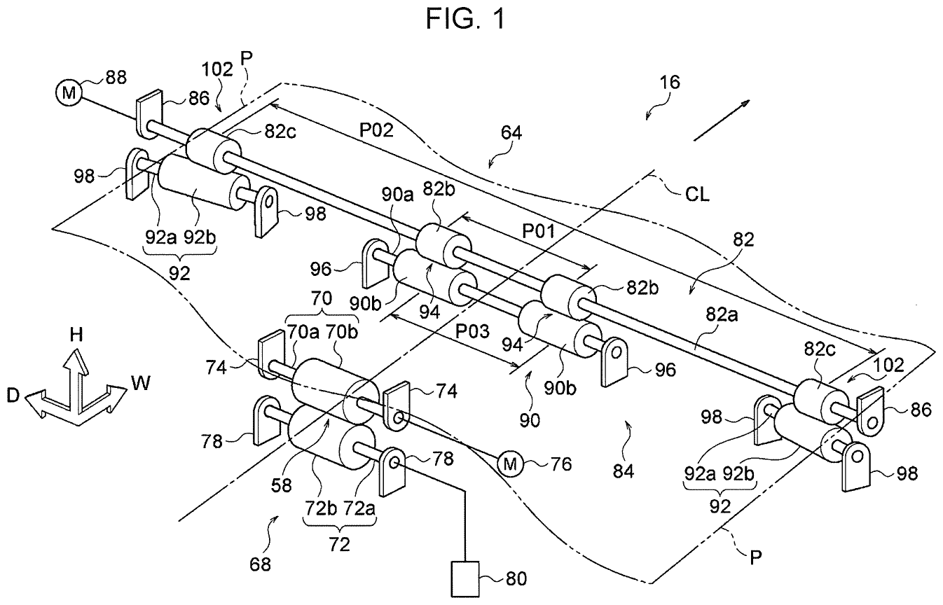

An example of a transport unit, which transports a sheet P, and an example of an image forming apparatus according to a first exemplary embodiment of the present disclosure will be described with reference to FIGS. 1 to 7. In the drawings, arrow H indicates the top-bottom direction (vertical direction) of the image forming apparatus, arrow W indicates the apparatus width direction (horizontal direction) of the image forming apparatus, and arrow D indicates the depth direction (horizontal direction) of the image forming apparatus.

### Overall Configuration

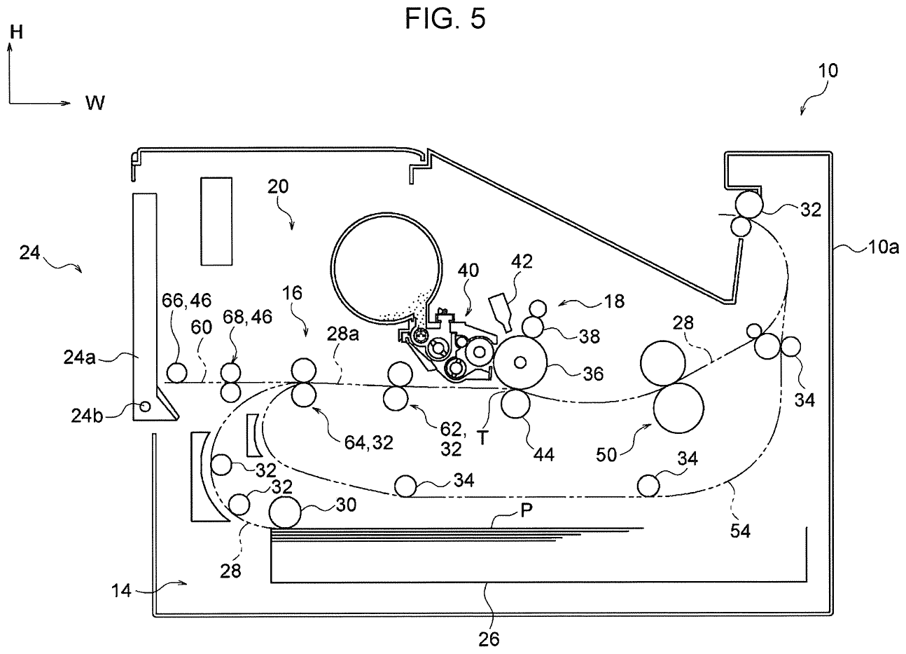

As shown in FIG. 5, an image forming apparatus 10 according to this exemplary embodiment includes, in this order from the lower side to the upper side in the top-bottom direction (direction of arrow H): a storage unit 14 that accommodates sheets P, serving as a recording media; a transport unit 16 that transports a sheet P stored in the storage unit 14; and an image forming section 20 that forms an image on the sheet P transported from the storage unit 14 by the transport unit 16. The image forming apparatus 10 also includes a manual feed unit 24, via which a sheet P can be fed from the outside of an image-forming-apparatus body 10a.

### Storage Unit

The storage unit 14 includes a storage member 26, which can be pulled out of the image-forming-apparatus body 10a of the image forming apparatus 10 in the apparatus width direction (i.e., the left side in FIG. 5). The storage member 26 stores a stack of sheets P. The storage unit 14 also includes a feed roller 30 for feeding a sheet P stored in the storage member 26 to a predetermined transport path 28, which constitutes the transport unit 16.

### Transport Unit

The transport unit 16 includes transport rollers 32, which transport the sheet P along the transport path 28, and transport rollers 34 that transport the sheet P along a reversing path 54 for reversing the sheet P.

The transport unit 16 also includes transport rollers 46 that transport the sheet P along a feed path 60, through which the sheet P fed from the manual feed unit 24 passes.

An upstream portion of the transport path 28 in the sheet transport direction has a U shape that is open on one side (i.e., the right side in FIG. 5) in the apparatus width direction. A registration roller 62, which constitutes the transport rollers 32 and feeds the sheet P to a transfer position T, at which an image is transferred to the sheet P, while adjusting the timing of transporting the sheet P to the transfer position T is disposed at a horizontal portion 28a of the U-shaped transport path 28. The horizontal portion 28a is located closer to the image forming section 20 and extends in the apparatus width direction. Furthermore, a preceding roller 64, which constitutes the transport rollers 32 and transports the sheet P toward the registration roller 62, is located upstream of the registration roller 62 in the sheet transport direction.

The feed path 60 extends from the other end portion (i.e., the portion opposite to the side closer to the transfer position T) in the width direction of the horizontal portion 28a of the transport path 28 toward the other end in the apparatus width direction. A feed roller 66, which constitutes the transport rollers 46 and feeds a sheet P loaded on a plate-shaped feed bed 24a (described below) to the feed path 60, and a separating roller 68, which separates sheets P into individual sheets, are disposed in the feed path 60. The separating roller 68 transfers the sheet P to the preceding roller 64.

The details of the separating roller 68 and the preceding roller 64 will be described below.

### Manual Feed Unit

The manual feed unit 24 constitutes a portion of a wall of the image-forming-apparatus body 10a on the other end in the apparatus width direction. The manual feed unit 24 includes the feed bed 24a, on which a sheet P to be fed is loaded, and a shaft 24b extending in the depth direction and supporting the feed bed 24a in a pivotable manner.

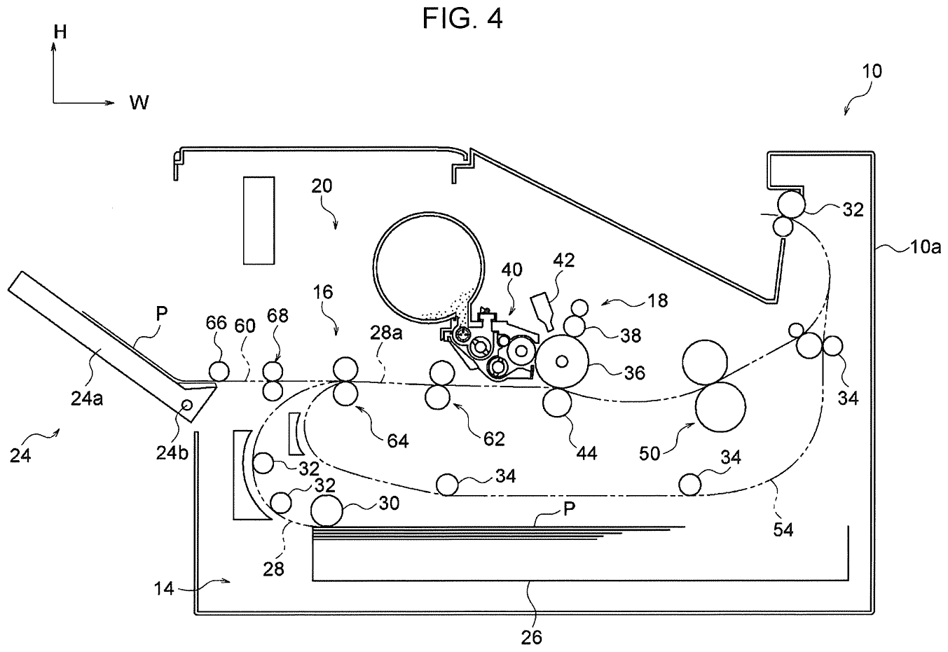

The feed bed 24a pivots about the shaft 24b between a closed position (see FIG. 5), at which the plate surface is oriented in the apparatus width direction and covers the inside of the image-forming-apparatus body 10a, and an open position (see FIG. 4), at which the inside of the image-forming-apparatus body 10a is exposed.

In this configuration, when the feed bed 24a is set to the open position, and a sheet P is loaded on the feed bed 24a, the feed roller 66 feeds the sheet P on the feed bed 24a to the feed path 60 and transfers the sheet P to the separating roller 68. Then, the separating roller 68 transfers the sheet P to the preceding roller 64, and the preceding roller 64 transfers the sheet P to the registration roller 62. In this way, the feed roller 66, the separating roller 68, the preceding roller 64, and the registration roller 62, in this order, transport the sheet P loaded on the feed bed 24a toward the transfer position T.

### Image Forming Section

The image forming section 20 includes an image forming unit 18 that forms a black image.

The image forming unit 18 includes an image carrier 36, a charging roller 38 that charges the surface of the image carrier 36, and an exposure device 42 that irradiates the charged image carrier 36 with exposure light. The image forming section 20 also includes a developing device 40 that develops an electrostatic latent image, which is formed as a result of the exposure device 42 irradiating the charged image carrier 36 with light, into a toner image.

The image forming section 20 also includes: a transfer roller 44, which transfers the toner image formed by the image forming unit 18 to the sheet P at the transfer position T, at which the image is transferred to the sheet P; and a fixing device 50 that applies heat and pressure to the sheet P to fix the toner image to the sheet P.

### Operation of Image Forming Apparatus

The image forming apparatus 10 forms an image as follows.

First, the charging roller 38 to which a voltage is applied is brought into contact with the surface of the image carrier 36 to uniformly charge the surface of the image carrier 36 at a predetermined and negative electric potential. Then, the exposure device 42 irradiates the charged surface of the image carrier 36 with exposure light according to data input from an external device, thus forming an electrostatic latent image.

As a result, an electrostatic latent image corresponding to the data is formed on the surface of the image carrier 36. The developing device 40 develops the electrostatic latent image into a visible toner image.

A sheet P fed by the feed roller 30 from the storage member 26 to the transport path 28 or a sheet P fed by the feed roller 66 from the manual feed unit 24 to the feed path 60 is transported to the transfer position T through the horizontal portion 28a of the transport path 28.

At the transfer position T, the sheet P is transported while being nipped between the image carrier 36 and the transfer roller 44. As a result, the toner image on the surface of the image carrier 36 is transferred to the sheet P.

The toner image transferred to the sheet P is fixed to the sheet P by the fixing device 50. The sheet P having the toner image fixed thereon is output from the image-forming-apparatus body 10a by the transport rollers 32.

### Relevant Part Configuration

The separating roller 68, the preceding roller 64, and other components constituting the transport unit 16 will be described. The transport unit 16 is an example of the sheet transport device, the separating roller 68 is an example of a second transport roller, and the preceding roller 64 is an example of a first transport roller.

### Separating Roller, Etc.

As shown in FIG. 1, the separating roller 68 is disposed upstream of the preceding roller 64 in the sheet transport direction so as to come into contact with the center of a transported sheet P in the width direction (i.e., the depth direction of the image forming apparatus of the present disclosure, hereinbelow the “sheet width direction”). For ease of explanation, the center of the transported sheet P in the sheet width direction will be referred to as a “transport center CL”. The transport center CL extends in the apparatus width direction as viewed from above.

The separating roller 68 has a symmetrical shape with respect to the transport center CL, as viewed in the thickness direction of the transported sheet P (i.e., the top-bottom direction of the image forming apparatus of the present disclosure, hereinbelow, the “sheet thickness direction”). The separating roller 68 includes a driving roller 70 (feed roller) and a separating roller 72 (retard roller), which nip the sheet P. The driving roller 70 is located above the sheet P, and the driving roller 70 is located opposite the separating roller 72 with the sheet P therebetween.

The driving roller 70 extends in the sheet width direction and includes a shaft 70a and a cylindrical roller 70b, through which the shaft 70a passes. The transport unit 16 includes two bearings 74 that support the shaft 70a in a rotatable manner and a motor 76 that generates a rotational force for rotating the driving roller 70. The motor 76 is controlled so as to stop exerting the rotational force when the separating roller 68 has transferred the sheet P to the preceding roller 64. More specifically, once a state in which the preceding roller 64 applies a transport force to the sheet P is established, the rotational force from the separating roller 68 stops. In this exemplary embodiment, for example, a sensor (not shown) detects the position of the sheet P to stop the rotational force from the separating roller 68. The term “cylindrical” as used in this exemplary embodiment also means “columnar”.

In this exemplary embodiment, the roller 70b is made of rubber and has an outside diameter of 16 mm and a length in the apparatus width direction of 26 mm, for example. The driving roller 70 is rotated by the rotational force from the rotation motor 76 such that the peripheral velocity of the outer circumferential surface of the roller 70b is 200 mm/s.

The separating roller 72 extends in the sheet width direction and includes a shaft 72a and a cylindrical roller 72b, through which the shaft 72a passes. The outer circumferential surface of the roller 72b is in contact with the outer circumferential surface of the roller 70b of the driving roller 70 in the top-bottom direction. The transport unit 16 includes two bearings 78 that support the shaft 72a in a rotatable manner and a torque limiter 80 that applies an axial force to the shaft 72a.

The roller 70b and the roller 72b form a nip part 58 that nip a portion of the sheet P in the sheet width direction. The nip part 58 is an example of a second nip part.

In this exemplary embodiment, the roller 72b is made of rubber and has an outside diameter of 16 mm and a length in the apparatus width direction of 26 mm, for example.

In this configuration, the sheet P to which a transport force is applied by the rotating driving roller 70 comes into contact with the outer circumferential surface of the separating roller 72, and the separating roller 72 is subjected to a rotational force due to the friction with sheet P. When this rotational force is less than or equal to a predetermined value, the torque limiter 80 inhibits the rotation of the separating roller 72.

With this configuration, in the case where more than one sheet P is being nipped by the nip part 58, the rotational force applied to the separating roller 72 is less than or equal to the predetermined value, allowing only the sheet P that is in contact with the rotating driving roller 70 to be transported downstream in the sheet transport direction. The sheet P that is not in contact with the driving roller 70 is stopped by the separating roller 72.

On the other hand, in the case where one sheet P is being nipped by the nip part 58, a rotational force applied to the separating roller 72 is greater than the predetermined value, and the separating roller 72 is rotated in a driven manner by the driving roller 70. As a result, the sheet P that is in contact with the driving roller 70 and the separating roller 72 is transported downstream in the sheet transport direction.

In this way, the separating roller 68 separates, by means of the driving roller 70 and the separating roller 72, the stacked sheets P to allow the sheets P to be transported one by one.

### Preceding Roller, Etc.

As shown in FIG. 1, the preceding roller 64 is disposed downstream of the separating roller 68 in the sheet transport direction. The preceding roller 64 has a symmetrical shape with respect to the transport center CL, as viewed in the sheet thickness direction. The preceding roller 64 includes a driving roller 82 and a driven roller 84, which nip a sheet P. The driving roller 82 is disposed above the transported sheet P, and the driven roller 84 is disposed opposite the driving roller 82 with the sheet P therebetween.

The preceding roller 64 is disposed so as to directly (i.e., without the intervention of any other member) receive the sheet P from the separating roller 68. More specifically, the preceding roller 64 is disposed such that the leading end of the sheet P coming from the separating roller 68 directly (i.e., without the intervention of any other member) comes into contact with the V-shaped portion, whose bottom is the nip part formed by the driving roller 82 and the driven roller 84. In this exemplary embodiment, the distance between the preceding roller 64 and the separating roller 68 (i.e., the distance between the nip part 58 and nip parts 94) is, for example, 50 mm, which is smaller than the length of the sheet P.

The driving roller 82 extends in the sheet width direction and includes a shaft 82a, two cylindrical rollers 82b, through which the shaft 82a passes, and two cylindrical rollers 82c, through which the shaft 82a passes. The two rollers 82c are disposed on the outer side of the two rollers 82b in the sheet width direction. The rollers 82c are an example of the other rollers, and the nip parts 94 are an example of first nip parts.

The transport unit 16 includes two bearings 86 that support the shaft 82a in a rotatable manner and a motor 88 that generates a rotational force for rotating the driving roller 82.

In this exemplary embodiment, the rollers 82b and 82c are made of rubber. For example, the rollers 82b and 82c have an outside diameter of 16 mm and a length in the apparatus width direction of 12 mm. The pitch P01 (the center-to-center distance) of the two rollers 82b in the sheet width direction is, for example, 55 mm, and the pitch P02 of the two rollers 82c is, for example, 260 mm. The driving roller 82 is rotated by the rotational force from the motor 88 such that the peripheral velocity of the outer circumferential surfaces of the rollers 82b and 82c is 200 mm/s.

The driven roller 84 includes a center roller 90 and two side rollers 92, which are disposed on the outer side of the center roller 90 in the sheet width direction.

The center roller 90 extends in the sheet width direction and includes a shaft 90a and two cylindrical rollers 90b, which are spaced apart in the sheet width direction and through which the shaft 90a passes. The outer circumferential surfaces of the two rollers 90b are in contact with the outer circumferential surfaces of the rollers 82b of the driving roller 82 in the top-bottom direction.

The transport unit 16 includes two bearings 96 that support the shaft 90a in a rotatable manner. The center roller 90 is rotated in a driven manner by the rotating driving roller 82. The rollers 82b and the rollers 90b form the two nip parts 94, which are spaced apart in the sheet width direction and nip portions of the sheet P. The nip parts 94 are an example of the first nip parts.

In this exemplary embodiment, the rollers 90b are made of resin (polyacetal) and have an outside diameter of 16 mm and a length in the apparatus width direction of 16 mm, for example. The pitch P03 (the center-to-center distance) of the two rollers 82b in the sheet width direction is, for example, 55 mm.

The axes of the side rollers 92 are inclined with respect to the sheet width direction, as viewed in the sheet thickness direction. The side rollers 92 each include a shaft 92a and a cylindrical roller 92b, through which the shaft 92a passes. Middle portions, in the axial direction, of the outer circumferential surfaces of the rollers 92b are in contact with middle portions, in the axial direction, of the outer circumferential surfaces of the rollers 82c of the driving roller 82 in the top-bottom direction. The transport unit 16 further includes four bearings 98 that support the shafts 92a in a rotatable manner. The side rollers 92 are rotated in a driven manner by the rotating driving roller 82. The rollers 92b are an example of first rollers.

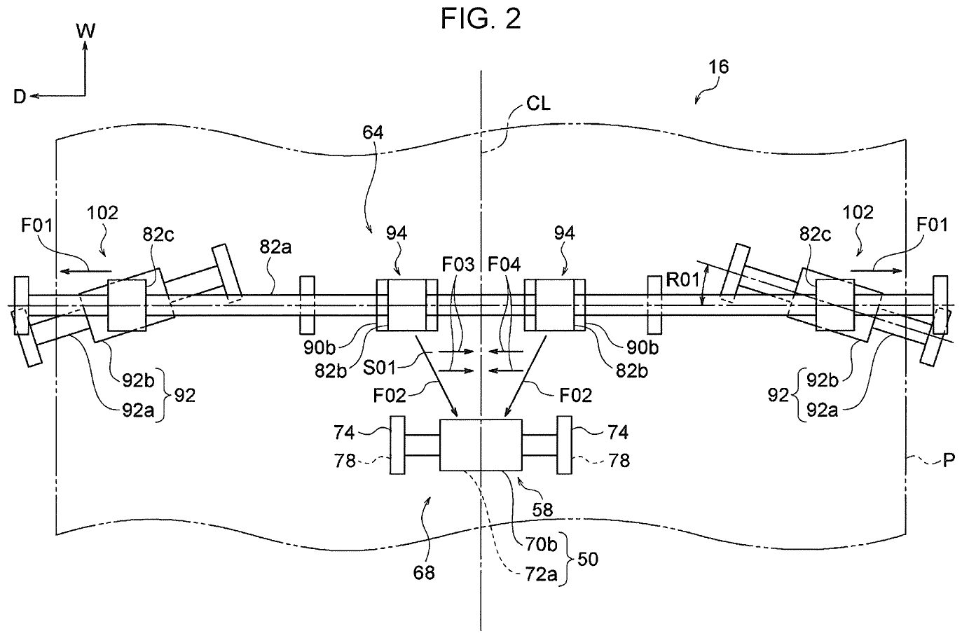

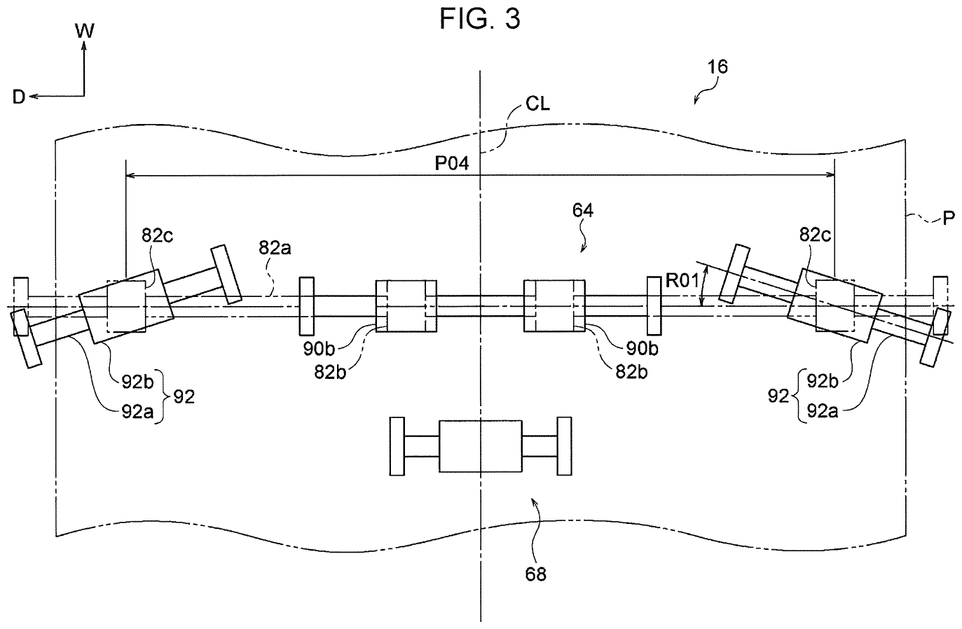

In this exemplary embodiment, as shown in FIGS. 2 and 3, the shafts 92a are inclined by, for example, 2 degrees (R01) with respect to the sheet width direction, as viewed in the sheet thickness direction. In the drawings, the inclination is illustrated in an exaggerated manner. More specifically, as viewed from above, the shafts 92a are inclined such that the outer ends (i.e., the ends farther from the transport center CL) in the sheet width direction are located upstream of the inner ends in the sheet transport direction.

The rollers 92b are made of resin (polyacetal) and have an outside diameter of 16 mm and a length in the axial direction of 16 mm, for example. The pitch P04 (the center-to-center distance) of the two rollers 82b in the sheet width direction is, for example, 260 mm.

In this exemplary embodiment, when a sheet P having a maximum size in the sheet width direction is transported, the outer portions of the sheet P in the sheet width direction are nipped between the rollers 92b of the side rollers 92 and the rollers 82c of the driving roller 82. The outer portions of the sheet P in the sheet width direction are at least portions within 25 from the edges of the sheet P when the length of the sheet P in the sheet width direction is assumed to be 100.

With this configuration, the preceding roller 64 shown in FIG. 1 receives the sheet P from the separating roller 68, nips the sheet P between the rotating driving roller 82 and the driven roller 84, which is rotated in a driven manner by the driving roller 82, and transports the sheet P downstream in the sheet transport direction.

Herein, the preceding roller 64 is disposed so as to directly (without the intervention of any other member) receive the sheet P transferred from the separating roller 68. Hence, the preceding roller 64 transports the sheet P received from the separating roller 68 such that the sheet P is in a flat state between the preceding roller 64 and the separating roller 68 (such that the sheet P is not in contact with something, such as a guide member). In other words, in a state in which the sheet P is nipped at both the preceding roller 64 and the separating roller 68, the portion of the sheet P between the preceding roller 64 and the separating roller 68 is in a flat state. The feed path 60 between the preceding roller 64 and the separating roller 68 is in a straight-line shape (so-called straight path), as viewed in the sheet width direction. The height of the nip part 58 is equal to the height of the nip parts 94.

A flat portion of a sheet P is more likely to be deformed in the sheet width direction than a curved portion of the sheet P.

Furthermore, the side rollers 92 of the driven roller 84 are inclined by 2 degrees with respect to the sheet width direction, as viewed in the sheet thickness direction. Hence, the side rollers 92 and the driving roller 82 pull the portions of the sheet P nipped between the rollers 82c of the driving roller 82 and the rollers 92b of the side rollers 92 outward in the sheet width direction.

The rollers 92b of the side rollers 92 and the rollers 82c of the driving roller 82 form two roller pairs 102, which apply, to the sheet P, a tension F01 pulling the sheet P outward in the sheet width direction (see FIG. 2). The roller pairs 102, which are formed of the rollers 92b and the rollers 82c, through which the shaft 82a pass, serve as tension parts, which pull the sheet P outward in the sheet width direction. The roller pairs 102 are an example of tension-applying parts. The rollers 92b and the rollers 82c are an example of one and another roller.

To increase the tension pulling the sheet P outward in the sheet width direction, it is desirable to increase the inclination of the side rollers 92 with respect to the sheet width direction. However, to suppress deformation of the sheet P, it is desirable to reduce the inclination of the side rollers 92. Hence, the inclination of the side rollers 92 with respect to the sheet width direction is, desirably, from 0.5 degrees to 5 degrees, more desirably, from 1 degree to 4 degrees, and most desirably, from 2 degrees to 3 degrees.

### Operation of Relevant Part Configuration

The operation of the relevant part configuration will be described below, together with a transport unit 516 according to a comparison example. First, the transport unit 516 according to the comparison example will be described, while focusing on the configurations that differ from the configuration of the transport unit 16.

### Transport Unit

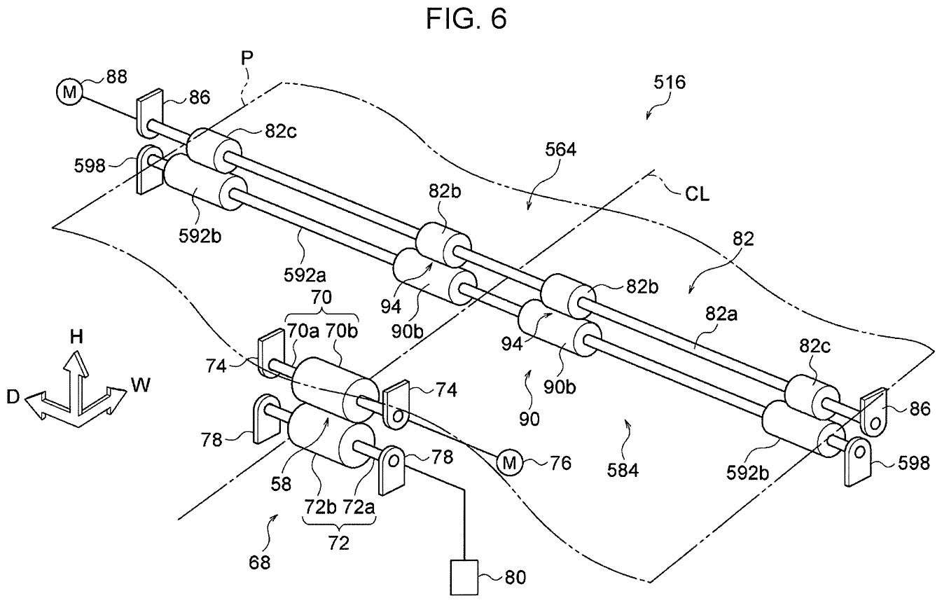

As shown in FIG. 6, the transport unit 516 includes the separating roller 68 and a preceding roller 564. The preceding roller 564 includes the driving roller 82 and a driven roller 584, which nip a sheet P.

The driven roller 584 extends in the sheet width direction and includes a shaft 592a, the two rollers 90b, through which the shaft 592a passes, and two rollers 592b, through which the shaft 592a passes and which are in contact with the rollers 82c. The transport unit 516 has two bearings 598 that support the shaft 592a in a rotatable manner.

The preceding roller 564 applies, to a sheet P, only a force that transports the sheet P downstream in the sheet transport direction.

### Operation of Transport Unit

The feed roller 66 shown in FIG. 4 feeds a sheet P loaded on the feed bed 24a of the manual feed unit 24 to the feed path 60. The feed roller 66 transfers the sheet P to the separating roller 68. The separating roller 68, as shown in FIGS. 1 and 6, receives the sheet P transported by the feed roller 66 and transports the sheet P one-by-one along the feed path 60 while nipping the sheet P between the driving roller 70 and the separating roller 72.

The separating roller 68 transfers the sheet P to the preceding roller 64 (564). Once the separating roller 68 has transferred the sheet P to the preceding roller 64 (564), the rotational force from the motor 76 stops, and the force exerted by the separating roller 68 to transport the sheet P stops.

The preceding roller 64 (564) receives the transported sheet P from the separating roller 68. The sheet P is nipped between the driving roller 82 and the driven roller 84 (584) and is transported downstream in the sheet transport direction.

In a state in which the sheet P is nipped at both the preceding roller 64 (564) and the separating roller 68, the portion of the sheet P between the preceding roller 64 (564) and the separating roller 68 is in a flat state.

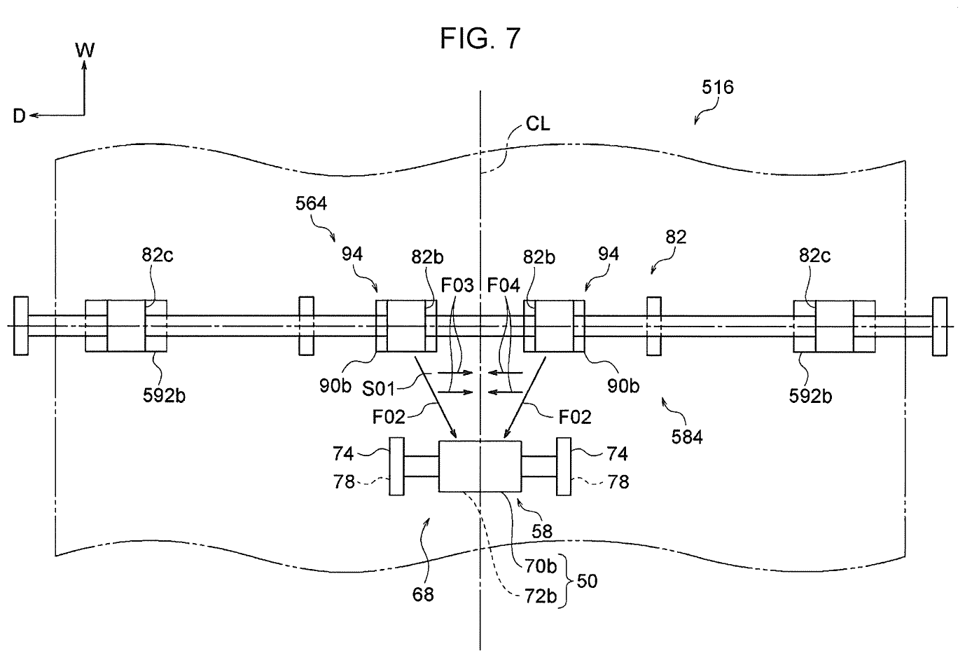

The sheet P that is being transported by the preceding roller 64 (564) is subjected to a force pulling upstream in the sheet transport direction by the separating roller 68, which has stopped exerting the transport force. More specifically, as shown in FIGS. 2 and 7, the tension F02 acts between the nip part 58 and the nip parts 94. More specifically, the tension F02 acts between the middle portion of the nip part 58 in the sheet width direction and the middle portions of the nip parts 94 in the sheet width direction. In the area (S01 in FIGS. 2 and 7) between, in the sheet width direction, the two positions at which the tension F02 is acting, a force in one direction (F03) and a force in the other direction (F04) in the sheet width direction are generated so as to form creases, in the sheet P, extending in the sheet transport direction.

Hence, in the transport unit 516 shown in FIGS. 6 and 7, creases extending in the sheet transport direction may be formed in the area S01 of the sheet P.

In contrast, in the transport unit 16 shown in FIGS. 1 and 2, the two roller pairs 102 apply, to the sheet P, the tension F01 pulling the sheet P outward in the sheet width direction. The tension F01 applied to the sheet P by the two roller pairs 102 suppresses formation, in the area S01, of creases extending in the sheet transport direction.

Then, the preceding roller 64 (564) of the transport unit 16 (516) transfers the transported sheet P to the registration roller 62 (see FIG. 4).

As has been described above, the preceding roller 64 of the transport unit 16 includes the two roller pairs 102, which apply, to the sheet P, the tension F01 pulling outward in the sheet width direction. Hence, compared with a case where the transport unit 516, which applies to a sheet P only a force that transports the sheet P downstream in the sheet transport direction, is provided, the formation of creases, in the sheet P, extending in the sheet transport direction is suppressed.

In the transport unit 16, the axes of the rollers 92b of the roller pairs 102 are inclined with respect to the sheet width direction, and the rollers 92b are in the shape of cylinders extending in the direction in which they are inclined. Hence, the tension F01 is applied to the sheet P with a simple structure, compared with a case where the tension F01 is applied to the sheet P by changing the friction between the rollers and the sheet P in the axial direction.

Furthermore, in the roller pairs 102 of the transport unit 16, the rollers 82c are rotated by a rotational force transmitted thereto, and the rollers 92b, whose axes are inclined, are rotated in a driven manner by the rotating rollers 82c. This configuration, in which the axial directions of the rollers 92b are inclined, is more simple than the configuration in which the axial direction of the rollers 82c, to which the rotational force is transmitted, is inclined with respect to the sheet width direction.

In the transport unit 16, the preceding roller 64 transports the sheet P received from the separating roller 68 such that the sheet P is in a flat state between the preceding roller 64 and the separating roller 68. The flat portion of the sheet P is more easily deformed in the sheet width direction, compared with the curved portion of the sheet P. However, because the transport unit 16 includes the two roller pairs 102, even in the configuration in which the sheet P is in a flat state between the preceding roller 64 and the separating roller 68, the formation of creases extending in the sheet transport direction is suppressed, compared with the transport unit 516 that applies, to the sheet P, only a force that transports the sheet P downstream in the sheet transport direction.

Furthermore, in the transport unit 16, the two roller pairs 102 are in contact with the outer portions of the sheet P in the sheet width direction. Hence, compared with a case where the tension-applying part is in contact with the inner portion of the sheet P in the sheet width direction, the tension F01 pulling outward in the sheet width direction is applied to the entire sheet P.

In the image forming apparatus 10, the formation of creases in the output sheet P is suppressed, compared with a case where the transport unit 516 is provided.

### Second Exemplary Embodiment

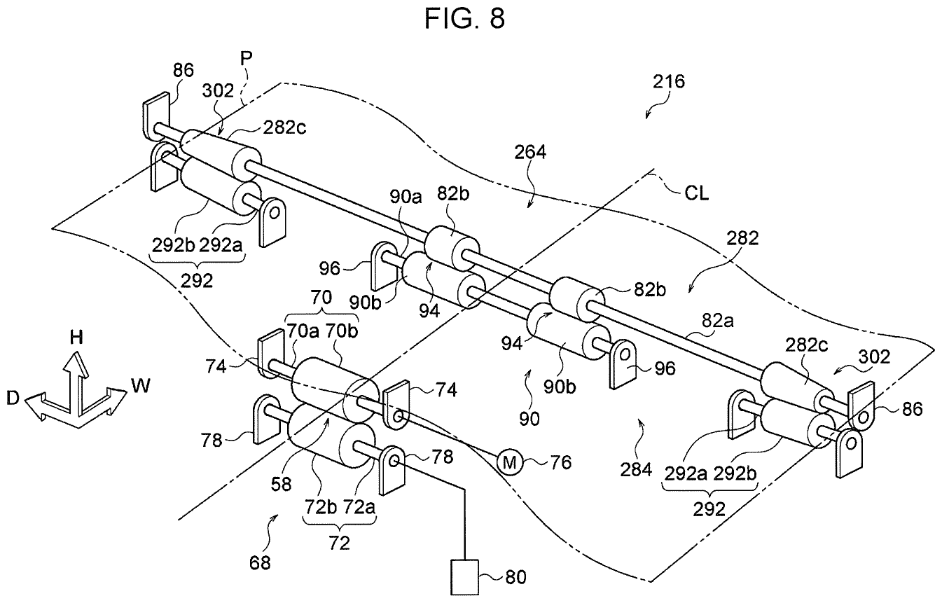

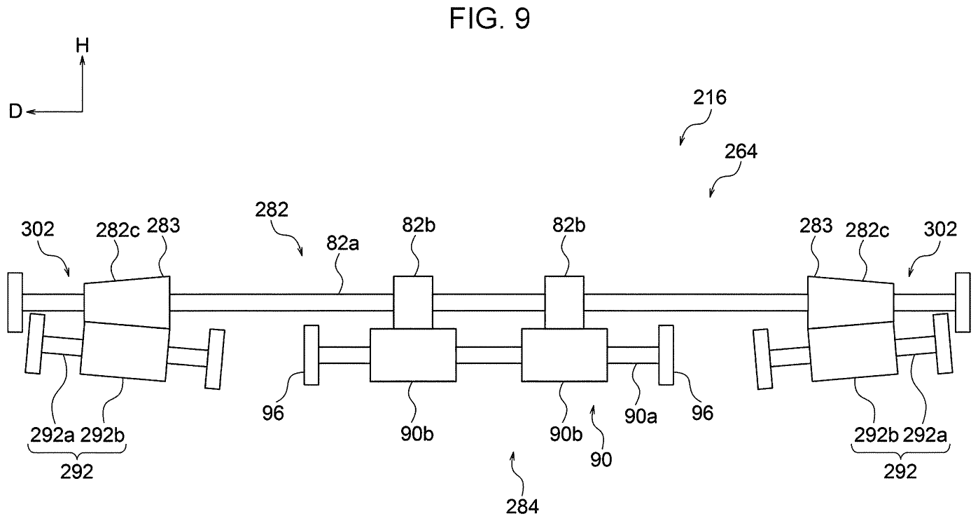

An example of a transport unit that transports sheets P and an example of an image forming apparatus according to a second exemplary embodiment of the present disclosure will be described with reference to FIGS. 8 and 9. Configurations of the second exemplary embodiment that differ from those of the first exemplary embodiment will be described.

As shown in FIG. 8, a transport unit 216 according to the second exemplary embodiment includes the separating roller 68 and a preceding roller 264. As shown in FIG. 9, the preceding roller 264 includes a driving roller 282 and a driven roller 284, which nip a sheet P. The transport unit 216 is an example of the sheet transport device, and the preceding roller 264 is an example of the first transport roller.

The driving roller 282 includes the shaft 82a, the two cylindrical rollers 82b, and two conical rollers 282c, through which the shaft 82a passes. The rollers 282c are provided on the outer side of the two rollers 82b in the sheet width direction. In each roller 282c, the outside diameter of the outer-side portion is smaller than the outside diameter of the inner-side portion in the sheet width direction. The outside diameter of the inner-side portions of the rollers 282c is equal to the outside diameter of the rollers 82b. The rollers 282c are made of rubber. The rollers 282c are an example of one roller.

The driven roller 284 includes the center roller 90 and two side rollers 292, which are provided on the outer side of the center roller 90 in the sheet width direction.

As shown in FIG. 9, the side rollers 292 have axes that are parallel to cone surfaces 283 of the rollers 282c, as viewed in the sheet transport direction, and have shafts 292a extending in the sheet width direction, as viewed in the sheet thickness direction. That is, the shafts 292a are parallel to the cone surfaces of the rollers 282c and extend at an angle with respect to the sheet width direction. The side rollers 292 also have cylindrical rollers 292b, through which the shafts 292a pass, and which are in contact with the cone surfaces 283 of the rollers 282c in the axial direction. The rollers 292b are made of resin (polyacetal). The rollers 292b are an example of the other roller.

As has been described above, the rollers 282c each have a conical shape in which the outside diameter of the outer-side portion is smaller than the outside diameter of the inner-side portion in the sheet width direction. Furthermore, the outer circumferential surfaces of the cylindrical rollers 292b are in contact with the cone surfaces 283 of the rollers 282c in the axial direction of the side rollers 292. Hence, the rotating driving roller 282 and the side rollers 292 pull portions of the sheet P nipped between the rollers 282c of the driving roller 282 and the rollers 292b of the side rollers 292 outward in the sheet width direction.

The rollers 292b of the side rollers 292 and the rollers 282c of the driving roller 282 form two roller pairs 302, which apply, to the sheet P, the tension F01 pulling the sheet P outward in the sheet width direction.

In the transport unit 216, the axes of the rollers 292b of the roller pairs 302 are inclined with respect to the sheet width direction, and the rollers 292b have a cylindrical shape extending in the inclination direction. Hence, compared with a case where the tension F01 is applied to the sheet P by changing, in the axial direction, the frictional force applied from the roller to the sheet P, the tension F01 is applied to the sheet P with a simple structure.

Furthermore, in the roller pairs 302 of the transport unit 216, the rollers 282c are rotated by the rotational force transmitted thereto, and the rollers 292b, whose axes are inclined, are rotated in a driven manner by the rotating rollers 282c, whose axes are inclined. This configuration, in which axial directions of the rollers 292b are inclined, is more simple than the configuration in which the axial direction of the rollers 282c, to which the rotational force is transmitted, is inclined with respect to the sheet width direction. The roller pairs 302 are an example of tension-applying parts.

The other effects of the second exemplary embodiment are the same as those of the first exemplary embodiment, except for the effect of the first exemplary embodiment achieved by the rollers 92b being inclined with respect to the sheet width direction as viewed in the sheet thickness direction.

### Third Exemplary Embodiment

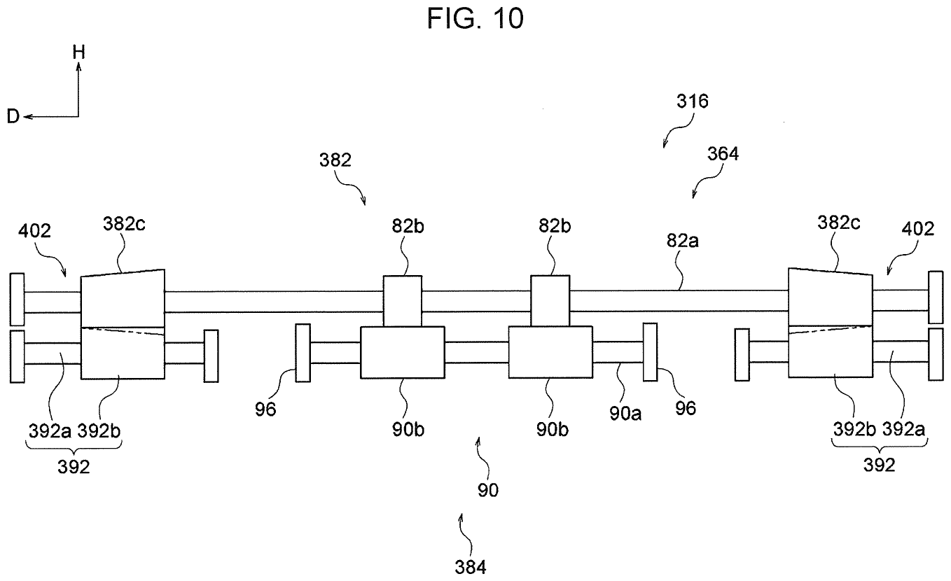

An example of a transport unit that transports a sheet P and an example of an image forming apparatus according to a third exemplary embodiment of the present disclosure will be described with reference to FIG. 10. Configurations of the third exemplary embodiment that differ from those of the first exemplary embodiment will be described.

A transport unit 316 according to the third exemplary embodiment includes the separating roller 68 and a preceding roller 364. As shown in FIG. 10, the preceding roller 364 also includes a driving roller 382 and a driven roller 384, which nip a sheet P. The transport unit 316 is an example of the sheet transport device, and the preceding roller 364 is an example of the first transport roller.

The driving roller 382 has the shaft 82a, the two cylindrical rollers 82b, and two conical rollers 382c, through which the shaft 82a passes. The rollers 382c are disposed on the outer side of the two rollers 82b in the sheet width direction. In each roller 382c, the outside diameter of the outer-side portion is smaller than the outside diameter of the inner-side portion in the sheet width direction. The outside diameter of the outer-side portions of the rollers 382c is equal to the outside diameter of the rollers 82b. The rollers 382c are made of rubber.

The driven roller 384 includes the center roller 90 and two side rollers 392, which are disposed on the outer side of the center roller 90 in the sheet width direction.

The side rollers 392 each include a shaft 392a extending in the sheet width direction, and a cylindrical roller 392b, through which the shaft 392a passes. More specifically, the shaft 392a is coaxial with the shaft 90a of the center roller 90, and the outside diameter of the rollers 392b is equal to the outside diameter of the rollers 90b of the center roller 90. The rollers 392b are made of resin (polyacetal).

With this configuration, the rollers 382c, which are made of rubber, is compressed at portions where they are in contact with the rollers 392b. As a result, a force that transports a sheet P in the sheet transport direction is greater at the inner-side portions of the rollers 382c than at the outer-side portions of the rollers 382c in the sheet width direction. Hence, the side rollers 392 and the driving roller 382 pull the portions of the sheet P nipped between the rollers 382c of the driving roller 382 and the rollers 392b of the side rollers 392 outward in the sheet width direction.

The rollers 392b of the side rollers 392 and the rollers 382c of the driving roller 382 form two roller pairs 402 that apply, to the sheet P, the tension F01 pulling the sheet P outward in the sheet width direction. The roller pairs 402 are an example of the tension-applying parts.

The other effects of the third exemplary embodiment are the same as those of the first exemplary embodiment, except for the effect of the first exemplary embodiment achieved by the rollers 92b being inclined with respect to the sheet width direction as viewed in the sheet thickness direction.

Although specific exemplary embodiments of the present disclosure have been described in detail above, the present disclosure is not limited to those exemplary embodiments, and it is obvious to those skilled in the art that various other exemplary embodiments are possible within the scope of the present disclosure. For example, in the above-described exemplary embodiments, the image forming apparatus 10 having the transport unit 16, 216, or 316 has been described. However, the present disclosure can be applied to any device that transports a sheet P, that is, the transport unit 16, 216, or 316 may be used as, for example, an image reading device, an automatic teller machine (ATM), a ticket machine, and a vending machine.

Furthermore, in the above-described exemplary embodiments, the two nip parts 94 are disposed symmetrical to each other with respect to the transport center CL, as viewed in the sheet thickness direction. Furthermore, the nip part 58 is disposed at the transport center CL, as viewed in the sheet thickness direction. Hence, the middle portion of one nip part 94 in the sheet width direction, the middle portion of the other nip part 94 in the sheet width direction, and the middle portion of the nip part 58 in the sheet width direction are located at positions corresponding to the corners of an isosceles triangle. However, it is only necessary that these three portions are located at positions corresponding to the corners of a triangle, which does not need to be an isosceles triangle. Furthermore, in this case, it is necessary that the nip part 58 does not overlap the center of at least one nip part 94 in the sheet width direction.

Another roller may be disposed between the two rollers 82b and between the two rollers 90b in the sheet width direction.

Furthermore, the driving roller and the driven roller in the preceding roller 64 may be exchanged. However, in this case, the effect achieved by the rollers whose axes are inclined being rotated in a driven manner cannot be obtained.

The rollers of the driving roller 82 may be connected to one another in the sheet width direction.

Furthermore, the rollers do not necessarily have to be integrally molded members, and the rollers may be formed by combining a plurality of parts.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. A sheet transport device comprising:
a first transport roller that transports a sheet and that has two first nip parts, which are spaced apart in a sheet width direction and which nip portions of the sheet;
a second transport roller that transports the sheet, that is disposed upstream of the first transport roller in a sheet transport direction, that has a second nip part, which nips a portion of the sheet at a position different from at least one of the first nip parts in the sheet width direction, and that stops exerting a force that transports the sheet when the sheet has been transferred to the first transport roller; and
two tension-applying parts that are provided on the first transport roller, on the outer side of the two first nip parts in the sheet width direction, and that apply, to the sheet, tension pulling the sheet outward in the sheet width direction.

2. The sheet transport device according to claim 1, wherein
the two tension-applying parts each have one and another roller that nip the sheet,
the one roller has an axis that is inclined with respect to the sheet width direction as viewed in a sheet thickness direction and has a cylindrical shape extending in an axial direction thereof,
the other roller has an axis that extends in the sheet width direction and has a cylindrical shape extending in an axial direction thereof.

3. The sheet transport device according to claim 2, wherein
the other roller is rotated by a rotational force transmitted from the first transport roller, and
the one roller is rotated in a driven manner by the rotating other roller.

4. The sheet transport device according to claim 1, wherein
the two tension-applying parts each have one and another roller that nip the sheet,
the one roller has an axis that extends in the sheet width direction and has a conical shape extending in the sheet width direction,
the other roller has an axis that is parallel to a cone surface of the one roller as viewed in the sheet transport direction and has a cylindrical shape extending in the axial direction thereof.

5. The sheet transport device according to claim 4, wherein
the one roller is rotated by a rotational force transmitted from the first transport roller, and
the other roller is rotated in a driven manner by the rotating first roller.

6. The sheet transport device according to claim 1, wherein the first transport roller transports the sheet received from the second transport roller such that the sheet is in a flat state between the first transport roller and the second transport roller.

7. The sheet transport device according to claim 2, wherein the first transport roller transports the sheet received from the second transport roller such that the sheet is in a flat state between the first transport roller and the second transport roller.

8. The sheet transport device according to claim 3, wherein the first transport roller transports the sheet received from the second transport roller such that the sheet is in a flat state between the first transport roller and the second transport roller.

9. The sheet transport device according to claim 4, wherein the first transport roller transports the sheet received from the second transport roller such that the sheet is in a flat state between the first transport roller and the second transport roller.

10. The sheet transport device according to claim 5, wherein the first transport roller transports the sheet received from the second transport roller such that the sheet is in a flat state between the first transport roller and the second transport roller.

11. An image forming apparatus comprising:
the sheet transport device according to claim 1; and
an image forming unit that forms an image on a sheet transported by the sheet transport device.
